(19) United States
(12) Patent Application Publication
(10) Pub. No.: US 2026/0086282 A1
(43) Pub. Date: Mar. 26, 2026

(54) GATED BACKEND OPTICAL INTERCONNECTS

(71) Applicants: Abhishek A. Sharma, Portland, OR (US); Wilfred Gomes, Portland, OR (US); Tahir Ghani, Portland, OR (US)

(72) Inventors: Abhishek A. Sharma, Portland, OR (US); Wilfred Gomes, Portland, OR (US); Tahir Ghani, Portland, OR (US)

(21) Appl. No.: 18/897,139

(22) Filed: Sep. 26, 2024

(51) Int. Cl. G02B 6/122; G02B 6/13

(52) U.S. Cl. CPC G02B 6/122; G02B 6/13

(57) ABSTRACT

Gated backend optical interconnects may enable high data-rate communication in a dense and cost-effective. In one example, an integrated circuit (IC) structure including a gated backend optical interconnect includes an interconnect layer over a device region, an optical interconnect in the interconnect layer, where the optical interconnect includes a dielectric material (e.g., a core material), an electrically conductive material at least partially surrounding a portion of the optical interconnect, and a semiconductor material between the electrically conductive material and the dielectric material. In some examples, the semiconductor material is a transition metal dichalcogenide (TMD) or a thin-film semiconductor. A conductive interconnect coupled with the electrically conductive material may enable application of an electrical field across the optical interconnect.

### BACKGROUND

For the past several decades, the scaling of features in integrated circuits (ICs) has been a driving force behind an ever-growing semiconductor industry. Scaling to smaller and smaller features enables increased densities of functional units on the limited real estate of semiconductor chips. For example, shrinking transistor size allows for the incorporation of an increased number of memory or logic devices on a chip, lending to the fabrication of products with increased capacity. The drive for the ever-increasing capacity, however, is not without issue. The necessity to optimize fabrication and performance of each component is becoming increasingly significant.

### BRIEF DESCRIPTION OF THE DRAWINGS

Embodiments will be readily understood by the following detailed description in conjunction with the accompanying drawings. To facilitate this description, like reference numerals designate like structural elements.

Embodiments are illustrated by way of example, and not by way of limitation, in the figures of the accompanying drawings.

FIG. 1 is a cross-sectional side view of an integrated circuit (IC) structure including gated backend optical interconnects, in accordance with various embodiments.

FIGS. 2A-2B are block diagrams of optical receiver and optical transmitter circuits that may be included in an IC structure with gated backend optical interconnects, in accordance with examples described herein.

FIGS. 3A-3B, 4A-4B, 5A-5B, and 6A-6B are different cross-sectional views of examples of IC structures that include gated backend optical interconnects, in accordance with embodiments disclosed herein.

FIGS. 7A-7D are top down plan views of examples of IC structures that include gated backend optical interconnects, in accordance with embodiments disclosed herein.

FIGS. 8A-8B are different cross-sectional views of examples of a gated backend optical interconnect, in accordance with embodiments disclosed herein.

FIG. 9 is a flow diagram of an example method for fabricating an IC structure including gated backend optical interconnects, in accordance with some embodiments.

FIGS. 10A-10F provide cross-sectional side views at various stages in the fabrication of an example IC structure according to the method of FIG. 9, in accordance with some embodiments.

FIG. 11 is a top view of a wafer and dies that may include any of the IC structures disclosed herein, in accordance with any of the embodiments disclosed herein.

FIG. 12 is a side, cross-sectional view of an IC package that may include any of the IC structures disclosed herein, in accordance with various embodiments.

FIG. 13 is a side, cross-sectional view of an IC device assembly that may include any of the IC structures disclosed herein, in accordance with any of the embodiments disclosed herein.

FIG. 14 is a block diagram of an example electrical device that may include any of the IC structures disclosed herein, in accordance with any of the embodiments disclosed herein.

### DETAILED DESCRIPTION

Disclosed herein are integrated circuit (IC) structures including gated backend optical interconnects.

Optical interconnects, such as waveguides are structures that guide electromagnetic waves along a specific path. Traditional waveguides may provide low loss and high power handling capabilities, but are typically formed as external components (e.g., cables, etc.) that interface with other parts of the system through transitions or connectors. Substrate Integrated Waveguides (SIWs) integrate waveguide-like structures directly into planar circuit boards. However, there are also limitations in the use of SIWs. For example, SIWs are typically formed in the substrate of a circuit board (e.g., the substrate of a package substrate or motherboard), may also be limited in terms of the substrates that they can be implemented in (e.g., single crystal substrates), and are generally not implemented together in the same area with other integrated circuits. Furthermore, challenges exist in implementing SIWs for sub-millimeter-wave signaling. For example, terahertz-compatible optical interconnects may suffer from excessive thermal noise interference.

Backend optical interconnects may be formed in backend of line (BEOL) layers together with conductive interconnects to enable high data-rate communication in a dense and cost-effective manner. One challenge that may be faced in fabricating backend optical interconnects stems from nonuniformities along etched surfaces of the backend optical interconnects. Such nonuniformities, commonly known as line edge roughness (LER), may be present at the sidewalls, bottom, and/or top of a backend optical interconnect depending on the process used to form the backend optical interconnect. LER may result in signal integrity issues due to, for example, reduced optical confinement in the optical interconnect.

In accordance with examples described herein, a gated backend optical interconnect may have the benefits of backend optical interconnects, and may further enable improved signal integrity. In one example, an IC structure including a gated backend optical interconnect includes an interconnect layer over a device region, an optical interconnect in the interconnect layer, where the optical interconnect includes a dielectric material (e.g., a core material), an electrically conductive material at least partially surrounding a portion of the optical interconnect, and a semiconductor material between the electrically conductive material and the dielectric material. In some examples, the semiconductor material is a transition metal dichalcogenide (TMD), a thin-film semiconductor, or other suitable semiconductor material. A conductive interconnect coupled with the electrically conductive material can then enable application of a field across the optical interconnect. According to examples, application of an electrical field may minimize the absorption of light, e.g., by preventing or minimizing the promotion of charge carriers. Thus, coating at least a portion of a backend optical interconnect with a thin semiconductor material and applying a voltage via a gate electrode around the thin semiconductor material may reduce light absorption from the optical interconnect and improve performance.

IC structures including gated backend optical interconnects as described herein may be implemented in one or more components associated with an IC or/and between various such components. In various embodiments, components associated with an IC include, for example, transistors, diodes, power sources, resistors, capacitors, inductors, sensors, transceivers, receivers, antennas, etc. Components associated with an IC may include those that are mounted on an IC or those connected to an IC. The IC may be either analog or digital and may be used in a number of applications, such as microprocessors, optoelectronics, logic blocks, audio amplifiers, etc., depending on the components associated with the IC. In some embodiments, IC structures as described herein may be included in a radio frequency IC (RFIC), which may, e.g., be included in any component associated with an IC of an RF receiver, an RF transmitter, or an RF transceiver, e.g., as used in telecommunications within base stations (BS) or user equipment (UE). Such components may include, but are not limited to, power amplifiers, low-noise amplifiers, RF filters (including arrays of RF filters, or RF filter banks), switches, upconverters, downconverters, and duplexers. In some embodiments, IC structures as described herein may be included in memory devices or circuits. In some embodiments, IC structures as described herein may be employed as part of a chipset for executing one or more related functions in a computer.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations. The terms “substantially,” “close,” “approximately,” “near,” and “about,” generally refer to being within +/−10% of a target value, e.g., within +/−5% of a target value, based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−10% of a target value, e.g., within +/−5% of a target value, based on the context of a particular value as described herein or as known in the art.

In the following description, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

In the drawings, while some schematic illustrations of example structures of various devices and assemblies described herein may be shown with precise right angles and straight lines, this is simply for ease of illustration, and embodiments of these assemblies may be curved, rounded, or otherwise irregularly shaped as dictated by, and sometimes inevitable due to, the fabricating processes used to fabricate semiconductor device assemblies. Therefore, it is to be understood that such schematic illustrations may not reflect real-life process limitations which may cause the features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of device fabrication. Inspection of layout and mask data and reverse engineering of parts of a device to reconstruct the circuit using e.g., optical microscopy, TEM, or SEM, and/or inspection of a cross-section of a device to detect the shape and the location of various device elements described herein using, e.g., Physical Failure Analysis (PFA) would allow determination of presence of IC structures including gated backend optical interconnects as described herein.

Various operations may be described as multiple discrete actions or operations in turn, in a manner that is most helpful in understanding the claimed subject matter. However, the order of description should not be construed as to imply that these operations are necessarily order dependent. These operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. The accompanying drawings are not necessarily drawn to scale.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner. Although some materials may be described in singular form, such materials may include a plurality of materials, e.g., a semiconductor material may include two or more different semiconductor materials.

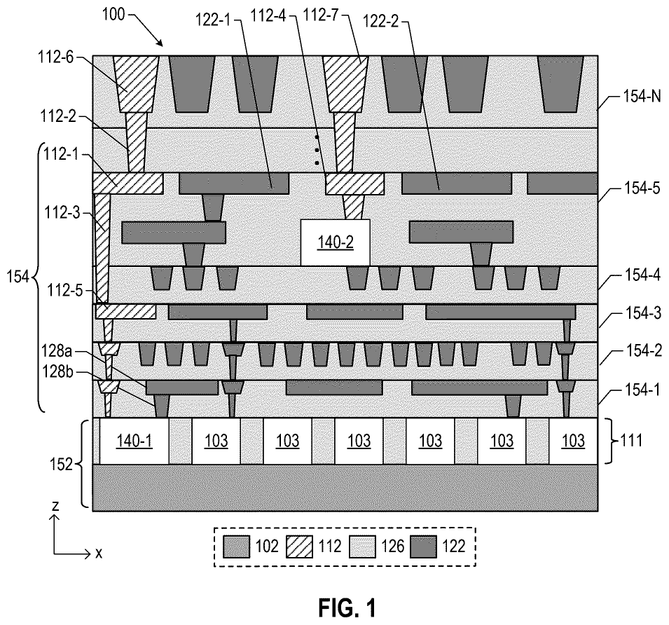

A number of elements referred to in the description of FIGS. 1, 3A-3B, 4A-4B, 5A-5B, 6A-6B, 7A-7B, 8A-8B, and 10A-10F with reference numerals are illustrated in these drawings with different patterns, with a legend showing the correspondence between the reference numerals and patterns being provided at the bottom of each drawing page containing FIGS. 1, 3A-3B, 4A-4B, 5A-5B, 6A-6B, 7A-7B, 8A-8B, and 10A-10F. For example, the legend illustrates that FIG. 1 uses different patterns to show a substrate 102, a conductive interconnect 122, and so on.

FIG. 1 is a cross-sectional side view of an IC structure 100 including gated backend optical interconnects, in accordance with various embodiments. The IC structure 100 includes FEOL layers 152 and BEOL layers 154. A FEOL layer refers to a layer formed in the FEOL, such as a device layer or device region. In the FEOL, individual semiconductor devices components (e.g., transistors, capacitors, resistors, etc.) can be patterned in a wafer. A BEOL layer refers to a layer formed in the BEOL, such as an interconnect layer (e.g., metal layer) of a metallization stack. In the BEOL, interconnect structures such as conductive lines and conductive vias, separated as needed by an insulator material, can be formed to interconnect individual components. The BEOL usually starts with forming the first metal layer on the wafer. The first metal layer is often called M0. Additional metal layers can be formed on top of M0, and these metal layers are often called M1, M2, and so on.

In the example illustrated in FIG. 1, the FEOL layer 152 includes a device region 111 over a substrate 102. The substrate 102 may be a semiconductor substrate composed of semiconductor material systems including, for example, N-type or P-type materials systems. In one implementation, the semiconductor substrate may be a crystalline substrate formed using a bulk silicon or a silicon-on-insulator (SOI) substructure. In other implementations, the semiconductor substrate may be formed using alternate materials, which may or may not be combined with silicon, that include, but are not limited to, germanium, silicon germanium, indium antimonide, lead telluride, indium arsenide, indium phosphide, gallium arsenide, aluminum gallium arsenide, aluminum arsenide, indium aluminum arsenide, aluminum indium antimonide, indium gallium arsenide, gallium nitride, indium gallium nitride, aluminum indium nitride or gallium antimonide, or other combinations of group III-V materials (i.e., materials from groups III and V of the periodic system of elements), group II-VI (i.e., materials from groups II and IV of the periodic system of elements), or group IV materials (i.e., materials from group IV of the periodic system of elements). In some embodiments, the substrate may be non-crystalline.

The device region 111 includes a plurality of devices 103. The devices 103 may be frontend devices (e.g., frontend transistors such as FinFETs, nanowire transistors, nanoribbon transistors, frontend memory cells, and/or other frontend devices). The devices 103 may include transistors of any architecture, such as any non-planar or planar architecture. Non-planar transistors such as double-gate transistors, tri-gate transistors, FinFETs, and nanowire/nanoribbon/nanosheet transistors refer to transistors having a non-planar architecture. In comparison to a planar architecture where the transistor channel has only one confinement surface, a non-planar architecture is any type of architecture where the transistor channel has more than one confinement surface. A confinement surface refers to a particular orientation of the channel surface that is confined by the gate field. Non-planar transistors potentially improve performance relative to transistors having a planar architecture, such as single-gate transistors. Nanoribbon transistors may be particularly advantageous for continued scaling of complementary metal-oxide-semiconductor (CMOS) technology nodes due to the potential to form gates on all four sides of a channel material (hence, such transistors are sometimes referred to as “gate all around” transistors).

The BEOL layers 154 may include a plurality of backend interconnects electrically coupled to (e.g., in electrically conductive contact with at least portions of) one or more of the plurality of FEOL devices of the FEOL layer 152. Various BEOL interconnect layers 154 may be/include one or more metal layers of a metallization stack of the IC device. Various metal layers of the BEOL interconnect layers 154 may be used to interconnect the various inputs and outputs of the devices (e.g., logic devices) in the FEOL layer 152. In one example, each of the BEOL interconnect layers 154 may include conductive interconnects 122, such as conductive vias and conductive lines/trenches. For example, the BEOL interconnect layer 154-1 includes a via portion 128b and a line or trench/interconnect portion 128a. The trench portion 128a of a metal layer is configured for transferring signals and power along electrically conductive (e.g., metal) lines (also sometimes referred to as “trenches”) extending in the x-y plane (e.g., in the x or y directions), while the via portion 128b of a metal layer is configured for transferring signals and power through electrically conductive vias extending in the z-direction, e.g., to any of the adjacent metal layers above or below. Accordingly, in one example, vias connect metal structures (e.g., metal lines or vias) from one metal layer to metal structures of an adjacent metal layer. While referred to as “metal” layers, various layers of the BEOL interconnect layers 154 may include only certain patterns of conductive metals, e.g., copper (Cu), aluminum (Al), tungsten (W), or cobalt (Co), or metal alloys, or more generally, patterns of an electrically conductive material, formed in an insulating medium such as an interlayer dielectric (ILD) 126. Although the conductive interconnects are shown with the same shading, different conductive interconnects in different layers may be formed from different conductive materials. The insulating medium may include any suitable ILD materials such as silicon oxide, carbon-doped silicon oxide, silicon carbide, silicon nitride, aluminum oxide, and/or silicon oxynitride. In some embodiments, the ILD 126 disposed between the interconnect structures in different ones of the interconnect layers may have different compositions; in other embodiments, the composition of the ILD 126 between different interconnect layers may be the same. The example illustrated in FIG. 1 includes N interconnect layers (of which 154-1, 154-2, 154-3, 154-4, 145-5, and 154-N are shown), where N is a positive integer that is greater than 1. IC structures may include fewer or more interconnect layers than those shown in FIG. 1.

In the example illustrated in FIG. 1, the IC structure 100 includes gated backend optical interconnects 112 in one or more of the BEOL layers 154. A gated optical interconnect may be or include, for example, a waveguide or wave confinement structure. The optical interconnect includes a dielectric material (e.g., a core material for transmission of optical signals), and may further include a material including a metal around the dielectric material. An optical interconnect may be considered a “backend optical interconnect” due to its location in a BEOL layer. The backend optical interconnects 112 may be gated backend optical interconnects in accordance with examples described herein. In one example, a semiconductor material is over two or more sides of an optical interconnect 112, and an electrically conductive material is over the semiconductor material.

In one example, the backend optical interconnects are in an interconnect layer that includes metal lines having a pitch that is at least around 250 nanometers (e.g., greater than or equal to about 250 nanometers, or in a range of about 250 to 4000 nanometers); however, in other examples, conductive interconnects may be present in interconnect layers with pitches that are smaller than 250 nanometers or greater than 4000 nanometers. In some examples, the backend optical interconnects may be in higher up metal layers (e.g., M10, M11, M12, M13, M14, M15, GM0, GM1, etc., where “MX” represents the (X+1)th metal layer over the frontend device region 111, and “GMX” represents the (X+1)th global or giant metal layer). In some examples, the optical interconnects 112 are coplanar with conductive interconnects. For example, the optical interconnect 112-4 is coplanar with and between conductive interconnects 122-1 and 122-2 (e.g., the optical interconnect 112-4 is in a plane with the conductive interconnects 122-1 and 122-2, where the plane is substantially parallel to the substrate 102 and device region 111, and parallel to the x-y plane as shown in FIG. 1, where the y-axis is going into and coming out of the plane).

The optical interconnects 112 may include optical vias that extend through and between layers (e.g., substantially orthogonal to the substrate 102 and device region 111) and optical lines that extend along one layer (e.g., substantially parallel to the substrate 102 and device region 111, and substantially parallel to the metal lines in that layer). For example, the optical interconnect 112-1 is substantially parallel to the conductive interconnect 122-1. In one such example, the optical interconnects 112 that are parallel to metal lines may have a thickness and/or width that are about the same as the metal lines in the same layer. For example, the optical interconnect 112-1 may have about the same thickness and/or width as the optical interconnect 122-1, where the thickness is a dimension of the optical interconnect 112-1 in a plane substantially orthogonal to the substrate 102 (e.g., along the z-axis), and the width is a dimension of the optical interconnect 112-1 in a plane substantially parallel to the substrate 102 (e.g., along the y-axis). In one example in which there are multiple adjacent optical interconnects in a layer, the optical interconnects may have about the same pitch as conductive interconnects in the same layer. The optical interconnects 112 may also include optical vias, such as the optical interconnects 112-1 and 112-4. An optical via may extend between and coupled with other optical structures in interconnect layers above and below the optical via. For example, the optical interconnect 112-3 extends through the layers 154-4 and 154-5, and is coupled with and between the optical interconnects 112-1 and 112-5.

The optical interconnects may be coupled with an optical receiver and/or transmitter in the IC structure 100. For example, the optical interconnects 112-1, 112-2, 112-3 and 112-5 are coupled with optical circuitry 140-1, which may include one or both of transmitter and receiver circuitry. The optical interconnect 112-4 is coupled with optical circuitry 140-2. Optical circuitry may be located in a FEOL layer or a BEOL layer. For example, the optical circuitry 140-1 is in the device region 111, and the optical circuitry 140-2 is in an interconnect layer 154-5. In some examples, an optical interconnect may be between optical circuitry of the IC structure 100 and an optical contact structure for coupling with other optical circuitry external to the IC structure 100. For example, the optical interconnect 112-4 is between the optical circuitry 140-2 and an optical interconnect 112-7, which may be coupled with an external optical interconnect. Similarly, the optical interconnect 112-2 is between the optical circuitry 140-1 and an optical interconnect 112-6, which may be coupled with an external optical interconnect.

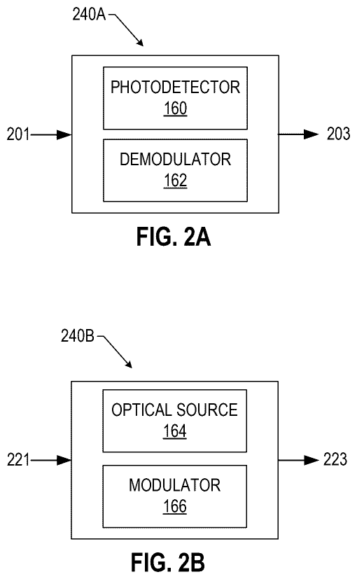

FIGS. 2A and 2B are block diagrams of optical circuitry with which the optical interconnects 112 may be coupled. FIG. 2A illustrates an optical receiver 240A and FIG. 2B illustrates an optical transmitter 240B. In some examples, optical circuitry may include both receiver and transmitter circuitry (e.g., an optical transceiver). The optical receiver 240A receives an optical signal 201 from an optical interconnect (e.g., one of the optical interconnects 112 of FIG. 1), which is detected with a photodetector 160 and demodulated with a demodulator 162 and output as an electrical signal 203. The optical receiver 240A outputs an electrical signal to a conductive interconnect (e.g., one of the conductive interconnects 122 of FIG. 1). The transmitter 240B receives an electrical signal 221 and generates and outputs an optical signal 223 with an optical source 164 and modulator 166. Optical receiver and transmitter circuitry may include additional circuitry (e.g., control circuitry, filters, amplifiers, etc.).

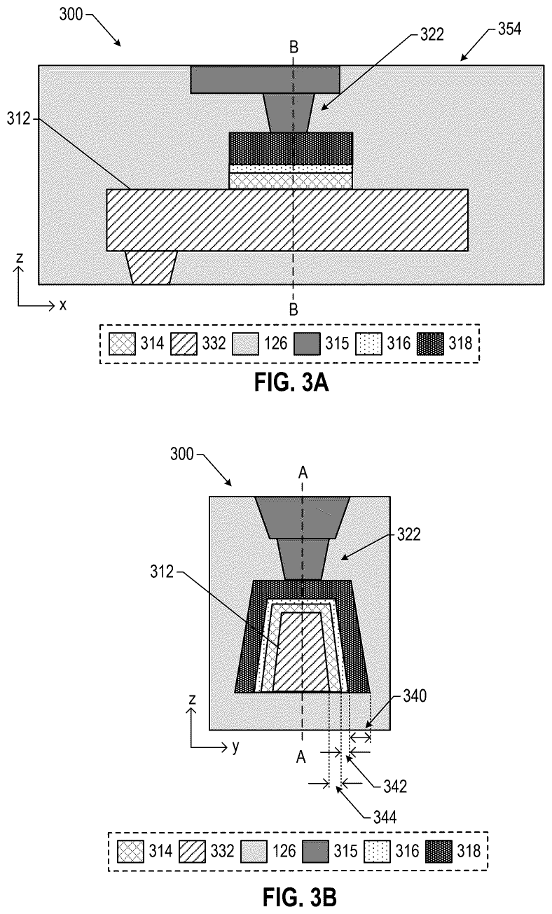

FIGS. 3A-3B, 4A-4B, 5A-5B, and 6A-6B are different cross-sectional views of examples of IC structures that include gated backend optical interconnects, in accordance with embodiments disclosed herein. Those figures of FIGS. 3A-3B, 4A-4B, 5A-5B, and 6A-6B that are labeled with a letter A (e.g., FIG. 3A) illustrate cross-sections in the x-z plane of the example coordinate system shown in FIG. 1 along a plane AA shown in a corresponding figure labeled with a letter B (e.g., along a plane AA shown in FIG. 3B). Those figures of FIGS. 3A-3B, 4A-4B, 5A-5B, and 6A-6B that are labeled with a letter B (e.g., FIG. 3B) illustrate cross-sections in the y-z plane of the example coordinate system shown in FIG. 1 along a plane BB shown in a corresponding figure labeled with a letter A (e.g., along a plane BB shown in FIG. 3A).

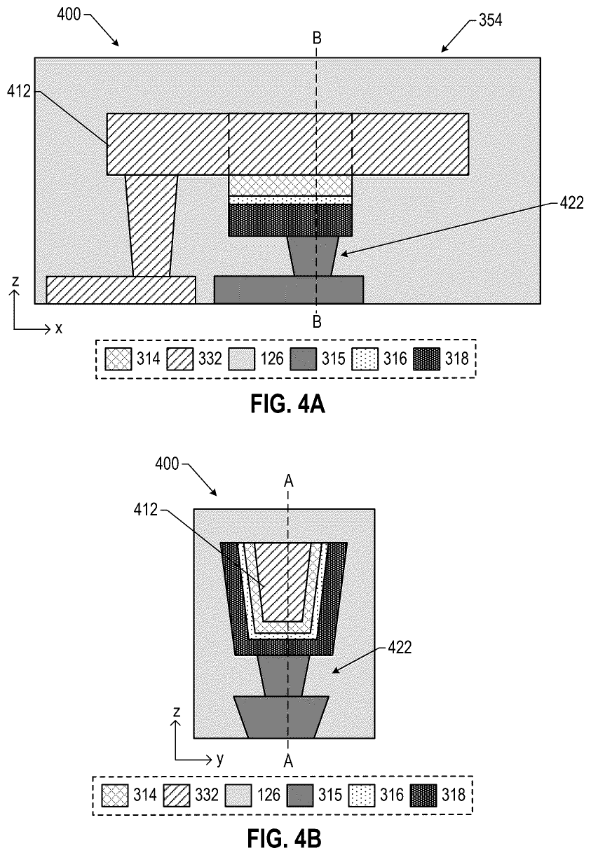

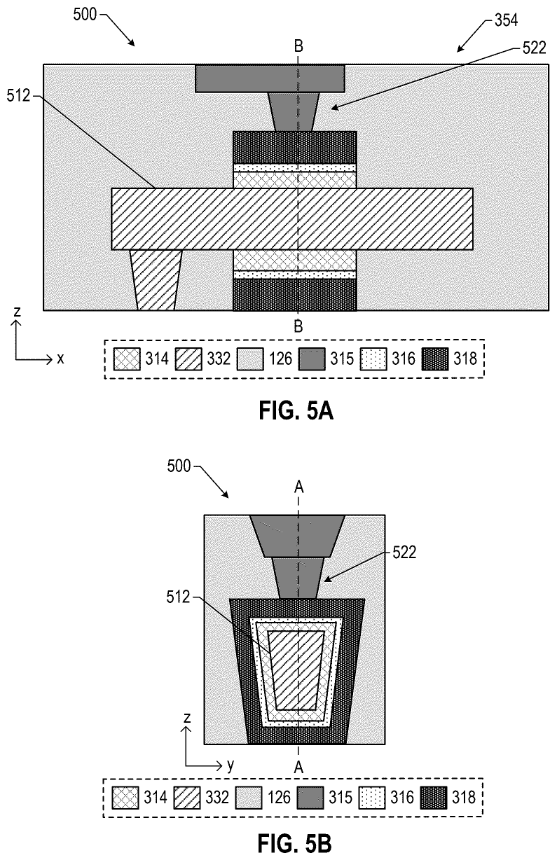

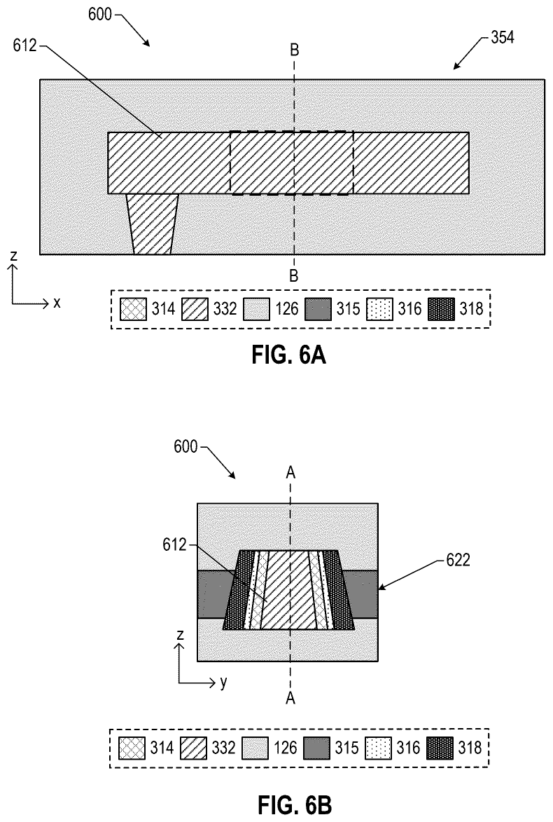

FIGS. 3A-3B, 4A-4B, 5A-5B, and 6A-6B each illustrate an example of an IC structure including a gated backend optical interconnect that is substantially parallel to a conductive line in the interconnect layer. FIGS. 3A-3B and 4A-4B illustrate example IC structures 300 and 400 in which a semiconductor material is over three sides of the backend optical interconnects. FIGS. 5A-5B illustrate an example IC structure 500 in which a semiconductor material is over four sides of the backend optical interconnect. FIGS. 6A-6B illustrate an example IC structure 600 in which a semiconductor material is over two sides of the backend optical interconnect.

Turning first to FIGS. 3A-3B, the IC structure 300 includes an optical interconnect 312 in an interconnect layer 354. The interconnect layer 354 includes an ILD 126, and the optical interconnect includes a dielectric material 332 as a core material or transmission material. The dielectric material 332 may be compatible with transmitting terahertz signals (e.g., signals in the frequency range of about 100 GHz to 10 THz, or greater than 10 THz). Terahertz signals may include signals having wavelengths in a range of about 3 millimeters to 30 micrometers, and in some examples, may be referred to as sub-millimeter-wave signals. In the example illustrated in FIGS. 3A-3B, the dielectric material 332 differs from the surrounding ILD 126 in the interconnect layer in which the optical interconnect 312 is disposed. In some examples, the dielectric material 332 includes one or more of aluminum nitride, silicon carbide, aluminum scandium nitride, aluminum silicon nitride, lithium niobate, and/or other materials suitable as an optical medium. The dielectric material 332 may have particular properties that make it suitable for transmitting optical signals. For example, the dielectric material 332 has a refractive index that is greater than the ILD 126. In one example, the refractive index of the dielectric material 332 is about 10-40% greater, about 15-35% greater, or about 25-30% greater than the refractive index of the ILD 126. Although not shown in FIGS. 3A-3B, a shielding material (e.g., a material including a metal) may be present around one or more sides of the optical interconnect 312.

The IC structure 300 further includes an electrically conductive material 318 at least partially surrounding a portion of the optical interconnect 312. As can be seen in FIG. 3B, the electrically conductive material 318 is over sidewalls and over a top of the optical interconnect 312. In one example, the optical interconnect 312 may have a tapered cross-sectional shape (such as shown in FIG. 3B) resulting from the processes used to form the optical interconnect 312. In the example illustrated in FIG. 3B, the top of the optical interconnect 312 is narrower than the bottom of the optical interconnect 312 (where the width of the optical interconnect 312 is a dimension of the optical interconnect 312 in a plane substantially parallel to the substrate, e.g., along the y-axis as shown in FIG. 3B). Thus, in the example illustrated in FIG. 3B, the electrically conductive material 318 is over the sidewalls and the narrower side or portion of the optical interconnect 312.

In one example, the electrically conductive material 318 is a metal gate. The electrically conductive material 318 may include one or more gate electrode materials. Examples of gate electrode materials may include: ruthenium, palladium, platinum, cobalt, nickel, and conductive metal oxides (e.g., ruthenium oxide), hafnium, zirconium, titanium, tantalum, aluminum, alloys of these metals, and carbides of these metals (e.g., hafnium carbide, zirconium carbide, titanium carbide, tantalum carbide, and aluminum carbide), and/or any other suitable conductive material. The thickness 340 of the electrically conductive material 318 on the sidewalls and/or over a top of the optical interconnect 312 may be in a range of about 5 to 50 nanometers. The thickness 340 on sidewalls of the optical interconnect 312 is a dimension of the electrically conductive material 318 in a plane substantially parallel to a device region (e.g., along the y-axis shown in FIG. 3B). The thickness over a top of the optical interconnect 312 is a dimension of the electrically conductive material 318 in a plane substantially orthogonal to the device region (e.g., along the z-axis as shown in FIG. 3B). The thickness 340 on the sidewalls and the thickness of the conductive material 318 over the top of the optical interconnect 312 may be about the same, or may be different.

The IC structure 300 further includes a semiconductor material 314 between the electrically conductive material 318 and the dielectric material 332 of the optical interconnect 312. In the example illustrated in FIG. 3B, the semiconductor material 314 is over the sidewalls of the optical interconnect 312 and over the top of the optical interconnect 312. In some examples, the material 314 may include a TMD. TMDs include semiconducting materials formed form a combination of a transition metal (e.g., molybdenum or tungsten) and a chalcogen (e.g., sulfur or selenium) in a monolayer having a hexagonal crystal structure. TMDs are atomically thin materials having the general formula MX₂, where M is a transition metal such as molybdenum (Mo), tungsten (W), or zirconium (Zr), and X is a chalcogen atom (sulfur (S), selenium (Se), or tellurium (Te)). TMDs that include Mo, W, or Zr as the transition metal are semiconducting. For example, MoS₂ and WS₂ are examples of N-type semiconductor materials, and MoSe₂ is an example of a P-type semiconductor material. TMD materials are in the class of 2D materials, also referred to as single-layer materials, such as graphene. 2D materials are crystalline materials that may be formed from a single material layer, e.g., a single layer of atoms. In some examples, a 2D material may include multiple monolayers and still be referred to as a 2D material. A single layer of a TMD, also referred to as a monolayer TMD, is composed of three atomic planes: two planes of the chalcogen atoms and one plane of the transition metal atoms. The transition metal (M) atoms are sandwiched between the two layers of the chalcogen (X) atoms.

In some examples, the semiconductor material 314 may be a thin-film semiconductor material, and/or a nitride or oxide-based semiconductor material (e.g., a semiconductor material including oxygen and/or nitrogen). For example, the such as a high mobility oxide semiconductor material, such as tin oxide, antimony oxide, indium oxide, indium tin oxide, titanium oxide, zinc oxide, indium zinc oxide, indium gallium zinc oxide (IGZO), gallium oxide, titanium oxynitride, ruthenium oxide, or tungsten oxide. In general, if the transistor formed in the nanoribbon is a thin-film transistor (TFT), tin oxide, cobalt oxide, copper oxide, antimony oxide, ruthenium oxide, tungsten oxide, zinc oxide, gallium oxide, titanium oxide, indium oxide, titanium oxynitride, indium tin oxide, indium zinc oxide, nickel oxide, niobium oxide, copper peroxide, IGZO, indium telluride, molybdenite, molybdenum diselenide, tungsten diselenide, tungsten disulfide, N- or P-type amorphous or polycrystalline silicon, germanium, indium gallium arsenide, silicon germanium, gallium nitride, aluminum gallium nitride, indium phosphite, and black phosphorus, each of which may possibly be doped with one or more of gallium, indium, aluminum, fluorine, boron, phosphorus, arsenic, nitrogen, tantalum, tungsten, and magnesium, etc. In one example, the semiconductor material 314 is a thin layer of the semiconductor material 314 lining the sidewalls of at least a portion of the optical interconnect 312. The thickness 344 of the semiconductor material 314 may be in a range of about one monolayer (e.g., about 0.3 to 0.65 nanometers) to 50 nanometers, or about 0.3 to 20 nanometers. The thickness 344 on sidewalls of the optical interconnect 312 is a dimension of the semiconductor material 314 in a plane substantially parallel to a device region (e.g., along the y-axis shown in FIG. 3B). The thickness over a top of the optical interconnect 312 is a dimension of the semiconductor material 314 in a plane substantially orthogonal to the device region (e.g., along the z-axis as shown in FIG. 3B). The thickness 344 on the sidewalls and the thickness of the semiconductor material 314 over the top of the optical interconnect 312 may be about the same, or may be different.

Referring again to FIGS. 3A-3B, a second dielectric material 316 (e.g., a gate insulator material) may be present between the semiconductor material 314 and the electrically conductive material 318. In some examples, the second dielectric material 316 includes a high-k dielectric material, such as one or more of: hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In one example, the thickness 342 of the second dielectric material 316 may be in a range of about 4 to 50 nanometers, where the thickness 342 on sidewalls of the optical interconnect 312 is a dimension of the dielectric material 316 in a plane substantially parallel to a device region (e.g., along the y-axis shown in FIG. 3B). The thickness over a top of the optical interconnect 312 is a dimension of the dielectric material 316 in a plane substantially orthogonal to the device region (e.g., along the z-axis as shown in FIG. 3B).

Thus, in the example illustrated in FIGS. 3A-3B, the IC structure 300 includes an optical interconnect 312 including a first dielectric material 332, a first layer including a semiconductor material 314 lining sidewalls of at least a portion of the optical interconnect 312, a second layer including an electrically conductive material 318 over the first layer, and a third layer including a second dielectric material 316 between the first layer and the second layer. In the example illustrated in FIGS. 3A-3B, the semiconductor material 314 is present over the top of the optical interconnect 312 and absent from the opposite side (e.g., absent from the bottom of the optical interconnect 312). The IC structure 300 further includes a conductive interconnect 322 coupled (e.g., conductively coupled, e.g., directly electrically connected) with the electrically conductive material 318, where the conductive interconnect 322 includes an electrically conductive material 315. In the example illustrated in FIGS. 3A-3B, conductive interconnect 322 is coupled with the electrically conductive material 318 that at least partially surrounds the optical interconnect 312 from a front side (e.g., from the top). The conductive material 315 may include any of the conductive interconnect materials mentioned above, or any other suitable electrically conductive material. The conductive material 315 may include substantially the same material composition as, or a different material composition from, the electrically conductive material 318. In the example illustrated in FIGS. 3A-3B, a portion of the conductive material 315 may be in contact with (e.g., in direct contact with such that there are no intervening materials) the electrically conductive material 318. A voltage may be applied to the electrically conductive material 318 via the conductive interconnect 322 to generate an electrical field that may improve the confinement of optical signals in the optical interconnect 312.

FIGS. 4A-4B illustrate another example IC structure 400 in which the semiconductor material 314 is over three sides of a backend optical interconnect 412. The IC structure 400 of FIGS. 4A-4B is similar to the IC structure 300 of FIGS. 3A-3B in that the optical interconnect 412 is substantially parallel to the device region, and the semiconductor material 314 is over sidewalls of the optical interconnect 412. The IC structure 400 of FIGS. 4A-4B differs from the IC structure 300 in that the semiconductor material 314 lines a bottom of the optical interconnect 412 (in contrast to the IC structure 300, in which the semiconductor material 314 is over a top of the optical interconnect 312). Thus, in the example illustrated in FIGS. 4A-4B, the semiconductor material 314 is present at the bottom of the optical interconnect 312 and absent from the opposite side (e.g., absent from over the top of the optical interconnect 312). In the cross-section shown in FIG. 4B, the optical interconnect 412 tapers in a direction towards the bottom. Thus, in the example illustrated in FIG. 4B, the semiconductor material 314 and the electrically conductive material 318 are over the narrower side of the optical interconnect 412. In the example illustrated in FIGS. 4A-4B, conductive interconnect 422 is coupled with the electrically conductive material 318 that at least partially surrounds the optical interconnect 412 from a back side (e.g., from the bottom).

FIGS. 5A-5B illustrate an example IC structure 500 in which the semiconductor material 314 is over four sides of a backend optical interconnect 512. The IC structure 500 of FIGS. 5A-5B is similar to the IC structures 300 and 400, discussed above, in that the optical interconnect 512 is substantially parallel to the device region, and the semiconductor material 314 is over sidewalls of the optical interconnect 512. The IC structure 500 further the semiconductor material 314 over a bottom and top of the optical interconnect 512. For example, in a cross-section in a plane that is orthogonal to the device region and orthogonal to the optical interconnect (e.g., in a cross-section along the y-z plane as shown in FIG. 5B), the dielectric material 332 of the optical interconnect 512 is surrounded by the semiconductor material 314 and surrounded by the electrically conductive material 318. Thus, in the example shown in FIGS. FIGS. 5A-5B, the semiconductor material 314 completely surrounds at least a portion of the optical interconnect 512. In various examples, a conductive interconnect 522 may be coupled with the electrically conductive material 318 surrounding the optical interconnect 512 from a front side (as shown in FIGS. 5A-5B) or from a back side.

FIGS. 6A-6B illustrate an example IC structure 600 in which the semiconductor material 314 over two sides of a backend optical interconnect 612. The IC structure 600 of FIGS. 6A-6B is similar to the IC structures 300, 400, and 500, discussed above, in that the optical interconnect 612 is substantially parallel to the device region, and the semiconductor material 314 is over sidewalls of the optical interconnect 612. The IC structure 600 differs from the previous IC structures 300, 400, and 500 in that the semiconductor material 314 is limited to the sidewalls of the optical interconnect 612, and is absent from over the bottom and top of the optical interconnect 612. Additionally, the IC structure 600 includes a conductive interconnect 622 that couples with the electrically conductive material 318 over the sidewalls of the optical interconnect 612 is coplanar with the optical interconnect 612 (as opposed to being in a layer above or below the optical interconnect 612). In one example, the conductive interconnect 622 is coplanar with and orthogonal to the optical interconnect 612.

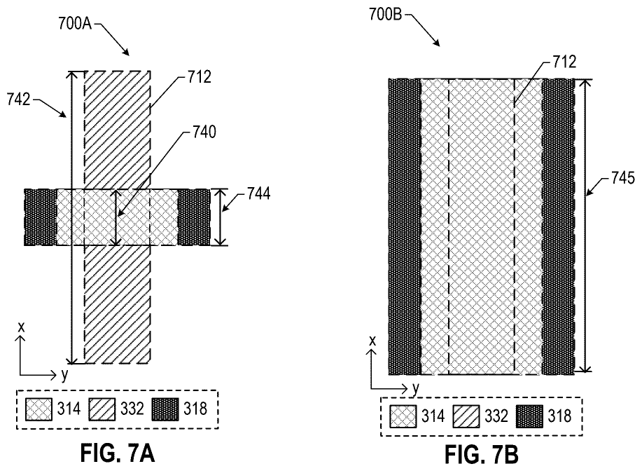

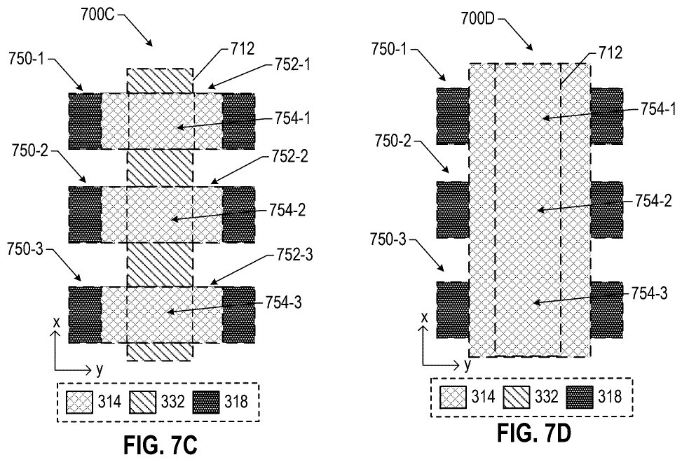

FIGS. 7A-7D are top down plan views of examples of IC structures that include gated backend optical interconnects, in accordance with embodiments disclosed herein. FIG. 7A illustrates an IC structure 700A in which only a section (a portion that is less than the entire length) of the optical interconnect 712 is coated with a semiconductor material 314 and an electrically conductive material 318. As can be seen in FIG. 7A, the optical interconnect 712 has a length 742 (e.g., where the length 742 is a dimension of the optical interconnect 712 in a plane that is substantially parallel to the device region, e.g., along the x-axis as shown in FIG. 7A). The semiconductor material 314 has a length 740 (where the length 740 is a dimension of the semiconductor material 314 that is parallel to the length742 of the optical interconnect 712), where the length 740 is smaller than the length 742. In the example illustrated in FIG. 7A, the electrically conductive material 318 (e.g., the gate electrode) has a length 744 that is substantially the same as the length 740 of the semiconductor material 314 (where the length of the electrically conductive material 318 is a dimension of the electrically conductive material 318 that is parallel to the length 742 of the optical interconnect 712).

FIG. 7B illustrates an example of an IC structure 700B in which the entire, or at least a majority of, the length of the optical interconnect 712 is coated with the semiconductor material 314. As can be seen in FIG. 7B, a continuous portion of the semiconductor material 314 is at least partially surrounding a majority of the length 742 of the optical interconnect 712. Similarly, in the example illustrated in FIG. 7B, a continuous portion of the electrically conductive material 318 is at least partially surrounding a majority of the length 742 of the optical interconnect 712. Thus, in the example illustrated in FIG. 7B, the length 745 of the semiconductor material is substantially the same as the length 742 of the optical interconnect 712.

FIG. 7C illustrates an example of an IC structure 700C in which portions or regions 752-1, 752-2, and 752-3 of the semiconductor material 314 and portions or regions 750-1, 750-2, and 750-3 of the electrically conductive material 318 are at least partially surrounding multiple portions 754-1, 754-2, and 754-3 of the optical interconnect 712. For example, the IC structure 700C includes a first region 752-1 of the semiconductor material 314 at least partially surrounding the first portion 754-1 and a second region 752-2 of the semiconductor material 314 at least partially surrounding a second portion 754-2 of the optical interconnect 712, where the first region 752-1 and the second region are coplanar. One or more further materials may be present between adjacent portions of the semiconductor material 314. For example, an insulator material (e.g., the ILD 126, discussed above) may be coplanar with and between the first region 752-1 and the second region 752-2 of the semiconductor material 314. Thus, the IC structure 700C includes multiple discrete regions 752-1, 752-2, and 752-3 of the semiconductor material 314. Similarly, multiple discrete regions 750-1, 750-2, and 750-3 of the electrically conductive material 318 may at least partially surround the portions 754-1, 754-2, and 754-3 of the optical interconnect 712. In one example, a first conductive structure (e.g., the region 750-1 of the electrically conductive material 318) is at least partially around the first portion 754-1 of the optical interconnect 712 and around the first region 752-1 of the semiconductor material 314, and a second conductive structure (e.g., the region 750-2 of the electrically conductive material 318) is at least partially around the second portion 754-2 of the optical interconnect 712 and around the second region 752-2 of the semiconductor material 314. The regions 750-1, 750-2 of the electrically conductive material 318 may also be separated from one another by one or more other materials (e.g., an insulator material such as the ILD 126, discussed above).

FIG. 7D illustrates an example of an IC structure 700D in which a continuous portion of the semiconductor material 314 is partially surrounding at least a majority of the length 742 of the optical interconnect 712, and in which there are multiple discrete conductive structures over the semiconductor material 314. For example, the IC structure 700D includes a first region 750-1 of the electrically conductive material 318 at least partially around the first portion 754-1 of the optical interconnect 712 and a second region 750-2 of the electrically conductive material 318 at least partially around the second portion 754-2 of the optical interconnect 712. The example arrangements of semiconductor material 314 and electrically conductive material 318 with respect to an optical interconnect are non-limiting examples, and different arrangements and dimensions may be possible. For example, although FIGS. 7C and 7D illustrate three discrete regions of a gate electrode material (e.g., the electrically conductive material 318), in other examples, fewer than three discrete regions or more than three discrete regions may be possible. Also, although the examples in FIGS. 7A-7D illustrate IC structures in which the semiconductor material 314 is around a top and sidewalls of the optical interconnect 712, the examples described above may apply to other arrangements (e.g., IC structures in which the semiconductor material 314 is not present over a top of the optical interconnect).

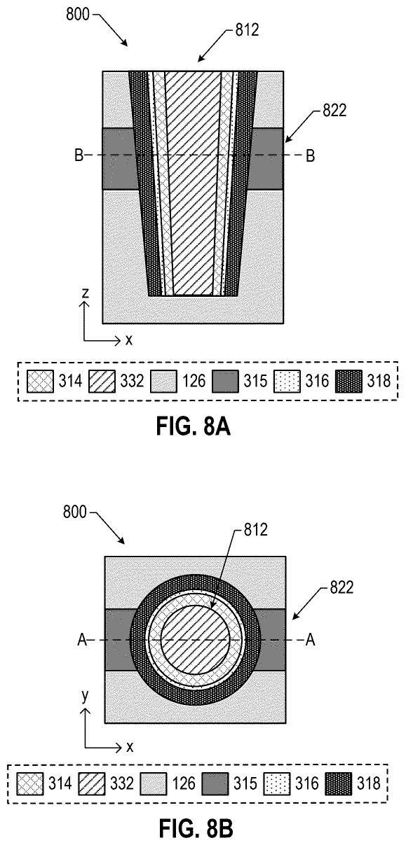

Thus, FIGS. 3A-3B, 4A-4B, 5A-5B, 6A-6B, and 7A-7D illustrate examples of gated backend optical interconnects that are parallel to metal lines (e.g., optical lines). FIGS. 8A-8B are different cross-sectional views of examples of a gated backend optical interconnect that is orthogonal to metal lines (e.g., an optical via). FIG. 8A illustrates a cross-section in the x-z plane of the example coordinate system shown in FIG. 1 along a plane AA shown in FIG. 8B. FIG. 8B illustrates a cross-section in the x-y plane of the example coordinate system shown in FIG. 1 along a plane BB shown in FIG. 8A. As can be seen in FIGS. 8A-8B, the IC structure 800 includes an optical interconnect 812 that is substantially orthogonal to a device region (e.g., the device region 111 of FIG. 1, which is not shown in FIGS. 8A-8B). A semiconductor material 314 is over sidewalls of the optical interconnect 812 and at least partially surrounding the dielectric material 332 of the optical interconnect 812. An electrically conductive material 318 is over the sidewalls and at least partially surrounding the semiconductor material 314. In the example illustrated in FIGS. 8A-8B, the semiconductor material 314 and the electrically conductive material 318 are completely surrounding the dielectric material 332, as can be seen in the cross-section shown in FIG. 8B. Similarly, the dielectric material 316 is between the electrically conductive material 318 and the semiconductor material 314, and completely surrounding the dielectric material 332. In the example illustrated in FIGS. 8A-8B, the semiconductor material 314, dielectric material 316, and the electrically conductive material 318 line the sidewalls of the optical interconnect 812 along the length of the optical interconnect 812 (where the length of the optical interconnect 812 is a dimension of the optical interconnect 812 in a plane that is substantially orthogonal to the device region, e.g., along the z-axis shown in FIG. 8A). In other examples, the semiconductor material 314, dielectric material 316, and the electrically conductive material 318 may line only a portion of the sidewalls of the optical interconnect 812. A conductive interconnect 822 may be a conductive line of the conductive material 315 that is orthogonal to the optical interconnect 822.

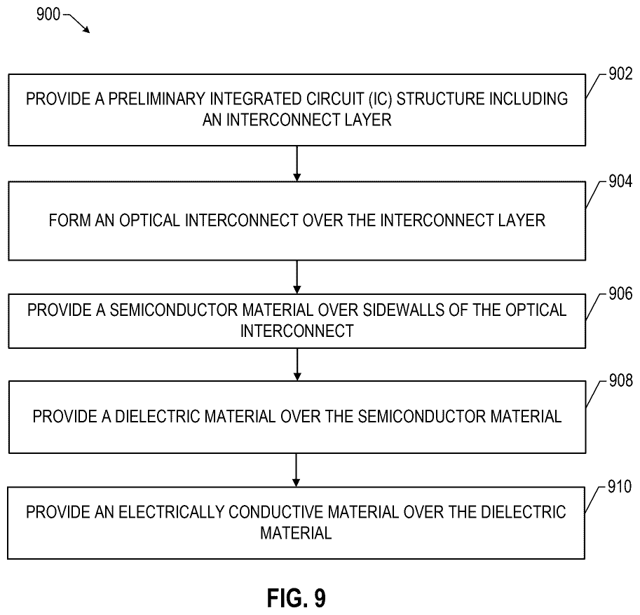

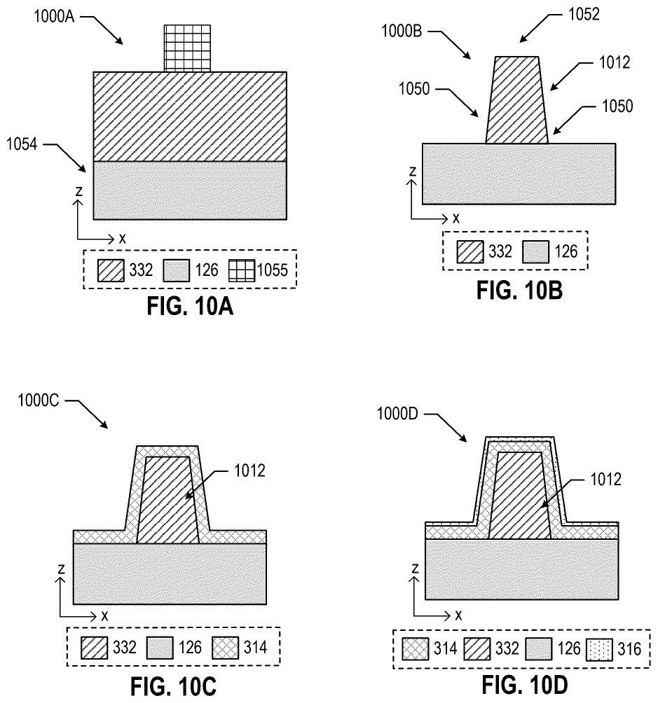

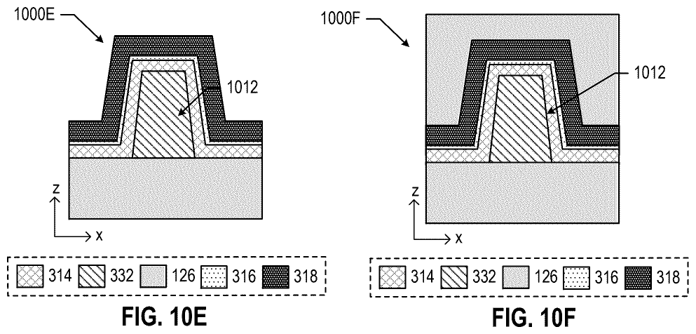

FIG. 9 is a flow diagram of an example method for fabricating an IC structure including gated backend optical interconnects, in accordance with some embodiments. FIGS. 10A-10F provide cross-sectional side views at various stages in the fabrication of an example IC structure according to the method of FIG. 9, in accordance with some embodiments. Although the operations of the method of FIG. 9 are illustrated once each and in a particular order, the operations may be performed in any suitable order and repeated as desired. For example, one or more operations may be performed in parallel to fabricate multiple IC structures including gated backend optical interconnects substantially simultaneously. In another example, the operations may be performed in a different order to reflect the structure in which gated backend optical interconnects will be implemented.

In addition, the example fabricating method of FIG. 9 may include other operations not specifically shown in FIG. 9, such as various cleaning or planarization operations as known in the art. For example, in some embodiments, a support, as well as layers of various other materials subsequently deposited thereon, may be cleaned prior to, after, or during any of the processes of the methods described herein, e.g., to remove oxides, surface-bound organic and metallic contaminants, as well as subsurface contamination. In some embodiments, cleaning may be carried out using e.g., a chemical solutions (such as peroxide), and/or with ultraviolet (UV) radiation combined with ozone, and/or oxidizing the surface (e.g., using thermal oxidation) then removing the oxide (e.g., using hydrofluoric acid (HF)). In another example, the intermediate IC structures described herein may be planarized prior to, after, or during any of the processes of the method of FIG. 9 described herein, e.g., to remove overburden or excess materials. In some embodiments, planarization may be carried out using either wet or dry planarization processes, e.g., planarization be a chemical mechanical planarization (CMP), which may be understood as a process that utilizes a polishing surface, an abrasive and a slurry to remove the overburden and planarize the surface.

Turning to FIG. 9, the method 900 begins with a process 902 of providing a preliminary IC structure including an interconnect layer, and a process 904 of forming an optical interconnect over the interconnect layer. The IC structure 1000A of FIG. 10A and the IC structure 1000B of FIG. 10B are example resulting IC structures of the processes 902 and 904. The IC structure 1000A includes an interconnect layer 1054 that includes an ILD 126, and which may include conductive interconnects and/or optical interconnects (interconnects are not shown in the interconnect layer 1054 in order to not clutter the drawing). Forming the optical interconnect may involve, for example, depositing a layer of a dielectric material 332, and patterning the layer of dielectric material 332. The material 332 may be any suitable optical medium, such as the examples discussed above, and may be provided with any suitable technique, such as atomic layer deposition (ALD), chemical vapor deposition (CVD), plasma enhanced CVD (PECVD), or/and physical vapor deposition (PVD) processes such as sputter. Patterning the dielectric material 332 may involve forming a mask 1055 over the dielectric material 332, such as shown in FIG. 10A, and etching the dielectric material 332 through openings in the mask 1055, such as shown in FIG. 10B, which includes an optical interconnect 1012. Any suitable etching technique, e.g., a dry etch, such as e.g., radio frequency (RF) reactive ion etch (RIE) or inductively coupled plasma (ICP) RIE may be used to etch the dielectric material 332 through openings in the mask 1055.

Etching the dielectric material 332 may result in defects or nonuniformities on the sidewalls 1050 of the optical interconnect 1012 and may also result in nonuniformities on the top 1052 of the optical interconnect 1012. In some examples, the sides of the optical interconnect 1012 that may have been damaged by an etch process may be lined with a semiconductor material. Thus, the method continues with a process 906 of providing a semiconductor material over sidewalls of the optical interconnect. Providing the semiconductor material may involve, for example, depositing a layer of the semiconductor material over sidewalls and over a top of the optical interconnect. The IC structure 1000C of FIG. 10C is an example resulting IC structure of the process 906. As can be seen in FIG. 10C, the IC structure 1000C includes a layer of the semiconductor material 314 over the top and over sidewalls of the optical interconnect 1012. The semiconductor material 314 may be any suitable semiconductor material (e.g., a TMD, thin-film semiconductor material, or other suitable semiconductor material), such as the examples discussed above, and may be provided with any suitable technique, such as the techniques discussed above with respect to FIG. 10A.

The method continues with a process 908 of providing a dielectric material over the semiconductor material. The IC structure 1000D of FIG. 10D is an example resulting IC structure of the process 908. As can be seen in FIG. 10D, the IC structure 1000D includes a layer of the dielectric material 316 over the semiconductor material 314, and over the top and over sidewalls of the optical interconnect 1012. The dielectric material 316 may be any suitable dielectric material (e.g., any suitable gate dielectric material), such as the examples discussed above, and may be provided with any suitable technique, such as the techniques discussed above with respect to FIG. 10A.

The method continues with a process 910 of providing an electrically conductive material over the dielectric material. As can be seen in FIG. 10E, the IC structure 1000E includes a layer of the electrically conductive material 318 over the dielectric material 316, and over the top and over sidewalls of the optical interconnect 1012. The electrically conductive material 318 may be any suitable conductive material (e.g., any suitable gate electrode material), such as the examples discussed above, and may be provided with any suitable technique, such as the techniques discussed above with respect to FIG. 10A.

The method may then continue with forming one or more additional interconnect layers, including providing an insulator material over the conductive material 318. The IC structure 1000F of FIG. 10F is an example resulting IC structure of providing an ILD 126 over the conductive material 318. A conductive interconnect may then be formed over the electrically conductive material 318, such as shown in FIGS. 3A and 3B. In another example, a conductive interconnect may be coupled with the electrically conductive material 318 from a layer below the optical interconnect, in addition to, or alternatively to, a conductive interconnect in a layer above the optical interconnect. In one such example, forming the optical interconnect may involve forming the optical interconnect over a conductive interconnect, and providing the electrically conductive material may involve depositing the electrically conductive material over and in electrical contact with the conductive interconnect.

In various examples, a different process may be used to form an optical interconnect. For example, forming the optical interconnect may involve depositing a layer of the ILD 126, forming a trench in the ILD 126, and depositing the dielectric material 332 in the opening. In one such example, providing the semiconductor material may involve, prior to depositing the dielectric material 332, depositing a layer of the semiconductor material 314 over sidewalls and over a bottom of the opening. Similarly, in one such example, providing the electrically conductive material may involve, prior to depositing the layer of the semiconductor material on the bottom and sidewalls of the opening, depositing a layer of the electrically conductive material over the sidewalls and over the bottom of the opening. In one such example, the cross-section of the resulting optical interconnect may taper in an opposite direction relative to the optical interconnect 1012 shown in FIG. 10B (e.g., the resulting optical interconnect may resemble the optical interconnect 412 of FIGS. 4A and 4B). In other examples, the method 900 may be used to form a gated backend optical interconnect that is orthogonal to the metal lines (e.g., an optical via that extends between two layers). In one such example, forming the optical interconnect may involve depositing an ILD 126, forming a via opening in the ILD, and depositing the dielectric material 332 in the via opening. In one such example, providing the semiconductor material may involve, prior to depositing the dielectric material 332, depositing a layer of the semiconductor material over sidewalls of the via opening.

Thus, FIG. 9 illustrates a method 900 for fabricating an IC structure including a gated backend optical interconnect. Performing the method 900 may result in several features in the final IC structure that are characteristic of the use of the method 900. For example, one such feature is illustrated in the IC structure shown in FIG. 10F, in which an IC structure 1000F includes an optical interconnect 1012 in a BEOL layer, where the optical interconnect 1012 includes a first dielectric material 332, a first layer including a semiconductor material 314 lining sidewalls of at least a portion of the optical interconnect 1012, a second layer including an electrically conductive material 318 over the first layer, and a third layer including a second dielectric material 316 between the first layer and the second layer.

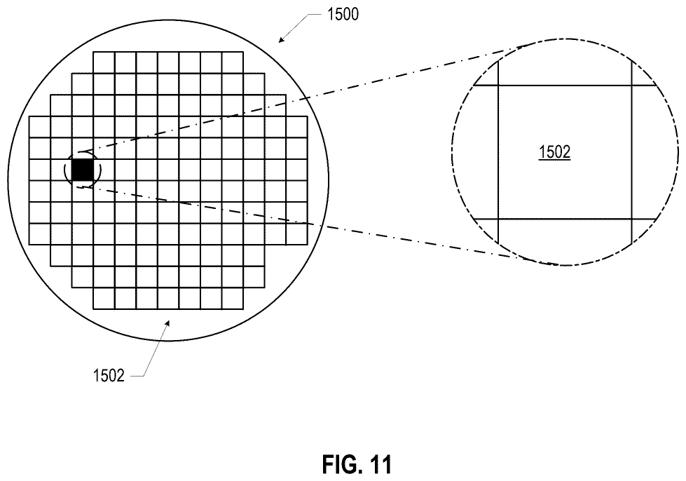

IC structures including backend optical interconnects in accordance with techniques described herein may be included in any suitable electronic component or electronic device. FIGS. 11-14 illustrate various examples of apparatuses that may include one or more of the IC structures with gated backend optical interconnects disclosed herein.

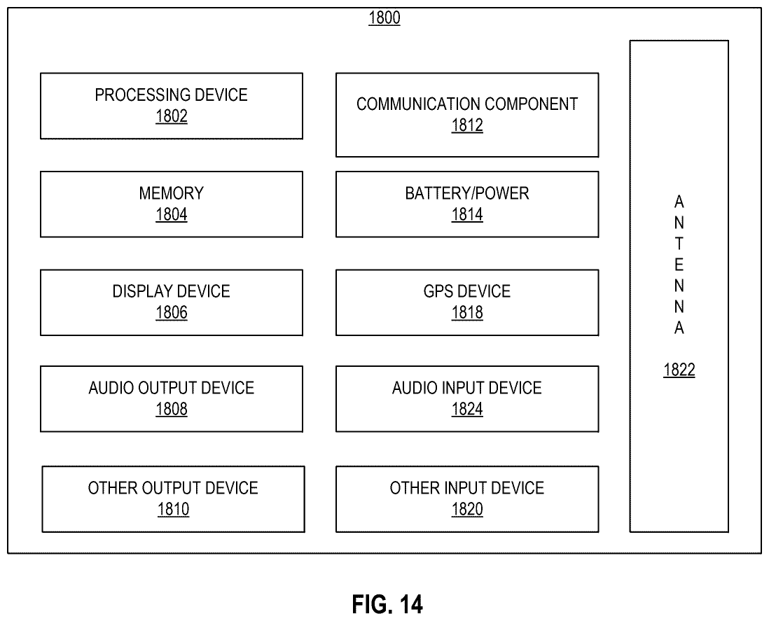

FIG. 11 is a top view of a wafer 1500 and dies 1502 that may include one or more IC structures in accordance with any of the embodiments disclosed herein. The wafer 1500 may be composed of semiconductor material and may include one or more dies 1502 having IC structures formed on a surface of the wafer 1500. Each of the dies 1502 may be a repeating unit of a semiconductor product that includes any suitable IC. After the fabrication of the semiconductor product is complete, the wafer 1500 may undergo a singulation process in which the dies 1502 are separated from one another to provide discrete “chips” of the semiconductor product. In some embodiments, the wafer 1500 or the die 1502 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1502. For example, a memory array formed by multiple memory devices may be formed on a same die 1502 as a processing device (e.g., the processing device 1802 of FIG. 14) or other logic that is configured to store information in the memory devices or execute instructions stored in the memory array.

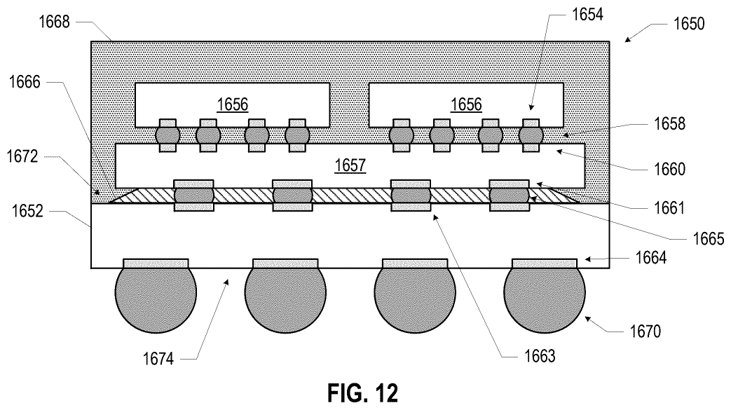

FIG. 12 is a side, cross-sectional view of an example IC package 1650 that may include one or more IC structures with gated backend optical interconnects in accordance with any of the embodiments disclosed herein. In some embodiments, the IC package 1650 may be a system-in-package (SiP).

The package substrate 1652 may be formed of a dielectric material (e.g., a ceramic, a buildup film, an epoxy film having filler particles therein, glass, an organic material, an inorganic material, combinations of organic and inorganic materials, embedded portions formed of different materials, etc.), and may have conductive pathways extending through the dielectric material between the face 1672 and the face 1674, or between different locations on the face 1672, and/or between different locations on the face 1674.

The package substrate 1652 may include conductive contacts 1663 that are coupled to conductive pathways (not shown) through the package substrate 1652, allowing circuitry within the dies 1656 and/or the interposer 1657 to electrically couple to various ones of the conductive contacts 1664 (or to devices included in the package substrate 1652, not shown).

The IC package 1650 may include an interposer 1657 coupled to the package substrate 1652 via conductive contacts 1661 of the interposer 1657, first-level interconnects 1665, and the conductive contacts 1663 of the package substrate 1652. The first-level interconnects 1665 illustrated in FIG. 12 are solder bumps, but any suitable first-level interconnects 1665 may be used. In some embodiments, no interposer 1657 may be included in the IC package 1650; instead, the dies 1656 may be coupled directly to the conductive contacts 1663 at the face 1672 by first-level interconnects 1665. More generally, one or more dies 1656 may be coupled to the package substrate 1652 via any suitable structure (e.g., a silicon bridge, an organic bridge, one or more waveguides, one or more interposers, wirebonds, etc.).

The IC package 1650 may include one or more dies 1656 coupled to the interposer 1657 via conductive contacts 1654 of the dies 1656, first-level interconnects 1658, and conductive contacts 1660 of the interposer 1657. The conductive contacts 1660 may be coupled to conductive pathways (not shown) through the interposer 1657, allowing circuitry within the dies 1656 to electrically couple to various ones of the conductive contacts 1661 (or to other devices included in the interposer 1657, not shown). The first-level interconnects 1658 illustrated in FIG. 12 are solder bumps, but any suitable first-level interconnects 1658 may be used. As used herein, a “conductive contact” may refer to a portion of conductive material (e.g., metal) serving as an interface between different components; conductive contacts may be recessed in, flush with, or extending away from a surface of a component, and may take any suitable form (e.g., a conductive pad or socket).

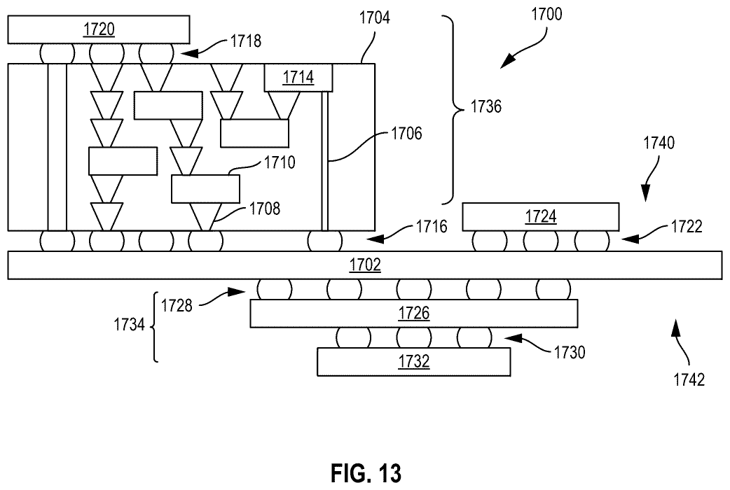

In some embodiments, an underfill material 1666 may be disposed between the package substrate 1652 and the interposer 1657 around the first-level interconnects 1665, and a mold compound 1668 may be disposed around the dies 1656 and the interposer 1657 and in contact with the package substrate 1652. In some embodiments, the underfill material 1666 may be the same as the mold compound 1668. Example materials that may be used for the underfill material 1666 and the mold compound 1668 are epoxy mold materials, as suitable. Second-level interconnects 1670 may be coupled to the conductive contacts 1664. The second-level interconnects 1670 illustrated in FIG. 12 are solder balls (e.g., for a ball grid array arrangement), but any suitable second-level interconnects 1670 may be used (e.g., pins in a pin grid array arrangement or lands in a land grid array arrangement). The second-level interconnects 1670 may be used to couple the IC package 1650 to another component, such as a circuit board (e.g., a motherboard), an interposer, or another IC package, as known in the art and as discussed below with reference to FIG. 13.

The dies 1656 may take the form of any of the embodiments of the die 1502 discussed herein. In embodiments in which the IC package 1650 includes multiple dies 1656, the IC package 1650 may be referred to as a multi-chip package (MCP). The dies 1656 may include circuitry to perform any desired functionality. For example, or more of the dies 1656 may be logic dies (e.g., silicon-based dies), and one or more of the dies 1656 may be memory dies (e.g., high bandwidth memory).

Although the IC package 1650 illustrated in FIG. 12 is a flip chip package, other package architectures may be used. For example, the IC package 1650 may be a ball grid array (BGA) package, such as an embedded wafer-level ball grid array (eWLB) package. In another example, the IC package 1650 may be a wafer-level chip scale package (WLCSP) or a panel fanout (FO) package. Although two dies 1656 are illustrated in the IC package 1650 of FIG. 12, an IC package 1650 may include any desired number of dies 1656. An IC package 1650 may include additional passive components, such as surface-mount resistors, capacitors, and inductors disposed on the first face 1672 or the second face 1674 of the package substrate 1652, or on either face of the interposer 1657. More generally, an IC package 1650 may include any other active or passive components known in the art.

FIG. 13 is a side, cross-sectional view of an IC device assembly 1700 that may include one or more IC packages or other electronic components (e.g., a die) including one or more IC structures with gated backend optical interconnects in accordance with any of the embodiments disclosed herein. The IC device assembly 1700 includes a number of components disposed on a circuit board 1702 (which may be, e.g., a motherboard). The IC device assembly 1700 includes components disposed on a first face 1740 of the circuit board 1702 and an opposing second face 1742 of the circuit board 1702; generally, components may be disposed on one or both faces 1740 and 1742. Any of the IC packages discussed below with reference to the IC device assembly 1700 may take the form of any of the embodiments of the IC package 1650 discussed above with reference to FIG. 12 (e.g., may include one or more IC structures in accordance with embodiments described herein).

In some embodiments, the circuit board 1702 may be a printed circuit board (PCB) including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 1702. In other embodiments, the circuit board 1702 may be a non-PCB substrate.

The IC device assembly 1700 illustrated in FIG. 13 includes a package-on-interposer structure 1736 coupled to the first face 1740 of the circuit board 1702 by coupling components 1716. The coupling components 1716 may electrically and mechanically couple the package-on-interposer structure 1736 to the circuit board 1702, and may include solder balls (as shown in FIG. 13), male and female portions of a socket, an adhesive, an underfill material, and/or any other suitable electrical and/or mechanical coupling structure.

The package-on-interposer structure 1736 may include an IC package 1720 coupled to a package interposer 1704 by coupling components 1718. The coupling components 1718 may take any suitable form for the application, such as the forms discussed above with reference to the coupling components 1716. Although a single IC package 1720 is shown in FIG. 13, multiple IC packages may be coupled to the package interposer 1704; indeed, additional interposers may be coupled to the package interposer 1704. The package interposer 1704 may provide an intervening substrate used to bridge the circuit board 1702 and the IC package 1720. The IC package 1720 may be or include, for example, a die (the die 1502 of FIG. 11), an IC device, or any other suitable component. Generally, the package interposer 1704 may spread a connection to a wider pitch or reroute a connection to a different connection. For example, the package interposer 1704 may couple the IC package 1720 (e.g., a die) to a set of BGA conductive contacts of the coupling components 1716 for coupling to the circuit board 1702. In the embodiment illustrated in FIG. 13, the IC package 1720 and the circuit board 1702 are attached to opposing sides of the package interposer 1704; in other embodiments, the IC package 1720 and the circuit board 1702 may be attached to a same side of the package interposer 1704. In some embodiments, three or more components may be interconnected by way of the package interposer 1704.

In some embodiments, the package interposer 1704 may be formed as a PCB, including multiple metal layers separated from one another by layers of dielectric material and interconnected by electrically conductive vias. In some embodiments, the package interposer 1704 may be formed of an epoxy resin, a fiberglass-reinforced epoxy resin, an epoxy resin with inorganic fillers, a ceramic material, or a polymer material such as polyimide. In some embodiments, the package interposer 1704 may be formed of alternate rigid or flexible materials that may include the same materials described above for use in a semiconductor substrate, such as silicon, germanium, and other group III-V and group IV materials. The package interposer 1704 may include metal lines 1710 and vias 1708, including but not limited to through-silicon vias (TSVs) 1706. The package interposer 1704 may further include embedded devices 1714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as RF devices, power amplifiers, power management devices, antennas, arrays, sensors, and microelectromechanical systems (MEMS) devices may also be formed on the package interposer 1704. The package-on-interposer structure 1736 may take the form of any of the package-on-interposer structures known in the art.

The IC device assembly 1700 may include an IC package 1724 coupled to the first face 1740 of the circuit board 1702 by coupling components 1722. The coupling components 1722 may take the form of any of the embodiments discussed above with reference to the coupling components 1716, and the IC package 1724 may take the form of any of the embodiments discussed above with reference to the IC package 1720.

The IC device assembly 1700 illustrated in FIG. 13 includes a package-on-package structure 1734 coupled to the second face 1742 of the circuit board 1702 by coupling components 1728. The package-on-package structure 1734 may include an IC package 1726 and an IC package 1732 coupled together by coupling components 1730 such that the IC package 1726 is disposed between the circuit board 1702 and the IC package 1732. The coupling components 1728 and 1730 may take the form of any of the embodiments of the coupling components 1716 discussed above, and the IC packages 1726 and 1732 may take the form of any of the embodiments of the IC package 1720 discussed above. The package-on-package structure 1734 may be configured in accordance with any of the package-on-package structures known in the art.

FIG. 14 is a block diagram of an example electrical device 1800 that may include one or more IC structures with gated backend optical interconnects in accordance with any of the embodiments disclosed herein. For example, any suitable ones of the components of the electrical device 1800 may include one or more of the IC device assemblies 1700, IC packages 1650, or dies 1502 disclosed herein. A number of components are illustrated in FIG. 14 as included in the electrical device 1800, but any one or more of these components may be omitted or duplicated, as suitable for the application. In some embodiments, some or all of the components included in the electrical device 1800 may be attached to one or more motherboards. In some embodiments, some or all of these components are fabricated onto a single system-on-a-chip (SoC) die.

Additionally, in various embodiments, the electrical device 1800 may not include one or more of the components illustrated in FIG. 14, but the electrical device 1800 may include interface circuitry for coupling to the one or more components. For example, the electrical device 1800 may not include a display device 1806, but may include display device interface circuitry (e.g., a connector and driver circuitry) to which a display device 1806 may be coupled. In another set of examples, the electrical device 1800 may not include an audio input device 1824 or an audio output device 1808, but may include audio input or output device interface circuitry (e.g., connectors and supporting circuitry) to which an audio input device 1824 or audio output device 1808 may be coupled.

The electrical device 1800 may include a processing device 1802 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1802 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. The electrical device 1800 may include a memory 1804, which may itself include one or more memory devices such as volatile memory (e.g., dynamic random access memory (DRAM)), nonvolatile memory (e.g., read-only memory (ROM)), flash memory, solid state memory, and/or a hard drive. In some embodiments, the memory 1804 may include memory that shares a die with the processing device 1802. This memory may be used as cache memory and may include embedded dynamic random access memory (eDRAM) or spin transfer torque magnetic random access memory (STT-MRAM).

In some embodiments, the electrical device 1800 may include a communication chip 1812 (e.g., one or more communication chips). For example, the communication chip 1812 may be configured for managing wireless communications for the transfer of data to and from the electrical device 1800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 1812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1812 may operate in accordance with other wireless protocols in other embodiments. The electrical device 1800 may include an antenna 1822 to facilitate wireless communications and/or to receive other wireless communications (such as AM or FM radio transmissions).

In some embodiments, the communication chip 1812 may manage wired communications, such as electrical, optical, or any other suitable communication protocols (e.g., the Ethernet). As noted above, the communication chip 1812 may include multiple communication chips. For instance, a first communication chip 1812 may be dedicated to shorter-range wireless communications such as Wi-Fi or Bluetooth, and a second communication chip 1812 may be dedicated to longer-range wireless communications such as global positioning system (GPS), EDGE, GPRS, CDMA, WiMAX, LTE, EV-DO, or others. In some embodiments, a first communication chip 1812 may be dedicated to wireless communications, and a second communication chip 1812 may be dedicated to wired communications.

The electrical device 1800 may include battery/power circuitry 1814. The battery/power circuitry 1814 may include one or more energy storage devices (e.g., batteries or capacitors) and/or circuitry for coupling components of the electrical device 1800 to an energy source separate from the electrical device 1800 (e.g., AC line power).

The electrical device 1800 may include a display device 1806 (or corresponding interface circuitry, as discussed above). The display device 1806 may include any visual indicators, such as a heads-up display, a computer monitor, a projector, a touchscreen display, a liquid crystal display (LCD), a light-emitting diode display, or a flat panel display.

The electrical device 1800 may include an audio output device 1808 (or corresponding interface circuitry, as discussed above). The audio output device 1808 may include any device that generates an audible indicator, such as speakers, headsets, or earbuds.

The electrical device 1800 may include an audio input device 1824 (or corresponding interface circuitry, as discussed above). The audio input device 1824 may include any device that generates a signal representative of a sound, such as microphones, microphone arrays, or digital instruments (e.g., instruments having a musical instrument digital interface (MIDI) output).

The electrical device 1800 may include a GPS device 1818 (or corresponding interface circuitry, as discussed above). The GPS device 1818 may be in communication with a satellite-based system and may receive a location of the electrical device 1800, as known in the art.

The electrical device 1800 may include another output device 1810 (or corresponding interface circuitry, as discussed above). Examples of the other output device 1810 may include an audio codec, a video codec, a printer, a wired or wireless transmitter for providing information to other devices, or an additional storage device.

The electrical device 1800 may include another input device 1820 (or corresponding interface circuitry, as discussed above). Examples of the other input device 1820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The electrical device 1800 may have any desired form factor, such as a handheld or mobile electrical device (e.g., a cell phone, a smart phone, a mobile internet device, a music player, a tablet computer, a laptop computer, a netbook computer, an ultrabook computer, a personal digital assistant (PDA), an ultra-mobile personal computer, etc.), a desktop electrical device, a server device or other networked computing component, a printer, a scanner, a monitor, a set-top box, an entertainment control unit, a vehicle control unit, a digital camera, a digital video recorder, or a wearable electrical device. In some embodiments, the electrical device 1800 may be any other electronic device that processes data.

The following paragraphs provide various examples of the embodiments disclosed herein.

Example 1 provides an IC structure, including a device region; an interconnect layer over the device region; an optical interconnect in the interconnect layer, where the optical interconnect includes a dielectric material; an electrically conductive material at least partially surrounding a portion of the optical interconnect; a semiconductor material between the electrically conductive material and the dielectric material; and a conductive interconnect coupled with the electrically conductive material.

Example 2 provides the IC structure of example 1, where: the optical interconnect is substantially parallel to the device region, and the semiconductor material is over sidewalls of the optical interconnect.

Example 3 provides the IC structure of any one of examples 1-2, where: the optical interconnect is substantially parallel to the device region, and the semiconductor material is over a top of the optical interconnect.

Example 4 provides the IC structure of any one of examples 1-3, where: the optical interconnect is substantially parallel to the device region, and in a cross-section in a plane that is orthogonal to the device region and orthogonal to the optical interconnect, the dielectric material is surrounded by the semiconductor material.

Example 5 provides the IC structure of any one of examples 1-4, where: the optical interconnect is substantially parallel to the device region, the optical interconnect has a first length, the semiconductor material has a second length, the second length is a dimension of the semiconductor material that is parallel to the first length, and the second length is smaller than the first length.

Example 6 provides the IC structure of example 5, where: the electrically conductive material has a third length that is substantially the same as the second length, and the third length is a dimension of the electrically conductive material that is parallel to the first length.

Example 7 provides the IC structure of any one of examples 1-6, where: a continuous portion of the semiconductor material is partially surrounding at least a majority of a length of the optical interconnect.

Example 8 provides the IC structure of example 7, where: the continuous portion is a first continuous portion, and a second continuous portion of the electrically conductive material is partially surrounding at least the majority of the length of the optical interconnect.

Example 9 provides the IC structure of example 7, where the portion is a first portion, and where the IC structure further includes a first conductive structure at least partially around the first portion; and a second conductive structure at least partially around a second portion of the optical interconnect, where the first conductive structure and the second conductive structure include the electrically conductive material.

Example 10 provides the IC structure of any one of examples 1-6, where: the portion is a first portion, the semiconductor material includes a first region of the semiconductor material at least partially surrounding the first portion and a second region of the semiconductor material at least partially surrounding a second portion of the optical interconnect, the first region is coplanar with the second region, and a further material is coplanar with and between the first region and the second region.

Example 11 provides the IC structure of example 10, further including a first conductive structure at least partially around the first region; and a second conductive structure at least partially around the second region, where the first conductive structure and the second conductive structure include the electrically conductive material.

Example 12 provides the IC structure of example 1, where: the optical interconnect is substantially orthogonal to the device region, and the semiconductor material is over sidewalls and at least partially surrounding the dielectric material, and the electrically conductive material is over the sidewalls and at least partially surrounding the semiconductor material.

Example 13 provides the IC structure of any one of examples 1-12, where: a thickness of the semiconductor material on a sidewall of the optical interconnect is in a range from about 0.3 to 50 nanometers, and the thickness is a dimension of the semiconductor material on the sidewall in a plane that is substantially parallel to the device region.

Example 14 provides the IC structure of any one of examples 1-13, where: the semiconductor material includes a transition metal dichalcogenide.

Example 15 provides the IC structure of any one of examples 1-14, where: the semiconductor material includes oxygen or nitrogen.

Example 16 provides the IC structure of any one of examples 1-15, where the dielectric material is a first dielectric material, and where the IC structure further includes a second dielectric material (e.g., high-k dielectric) between the semiconductor material and the electrically conductive material.

Example 17 provides an IC structure, including a BEOL layer; an optical interconnect in the BEOL layer, where the optical interconnect includes a first dielectric material; a first layer including a semiconductor material lining sidewalls of at least a portion of the optical interconnect; a second layer including an electrically conductive material over the first layer; a third layer including a second dielectric material between the first layer and the second layer; and a conductive interconnect coupled with the second layer.

Example 18 provides the IC structure of example 17, where: the optical interconnect includes an optical via, and the conductive interconnect includes a conductive line orthogonal to the optical via.

Example 19 provides an IC structure according to any one of examples 1-18, where the IC structure includes or is a part of a central processing unit.

Example 20 provides an IC structure according to any one of examples 1-19, where the IC structure includes or is a part of a memory device.

Example 21 provides an IC structure according to any one of examples 1-20, where the IC structure includes or is a part of a logic circuit.

Example 22 provides an IC structure according to any one of examples 1-21, where the IC structure includes or is a part of input/output circuitry.

Example 23 provides an IC structure according to any one of examples 1-22, where the IC structure includes or is a part of a field programmable gate array transceiver.

Example 24 provides an IC structure according to any one of examples 1-23, where the IC structure includes or is a part of a field programmable gate array logic.

Example 25 provides an IC structure according to any one of examples 1-24, where the IC structure includes or is a part of a power delivery circuitry.

Example 26 provides an IC package that includes an IC die including an IC structure according to any one of examples 1-25; and a further IC component, coupled to the IC die.

Example 27 provides an IC package according to example 26 where the further IC component includes a package substrate.

Example 28 provides an IC package according to example 26, where the further IC component includes an interposer.

Example 29 provides an IC package according to example 26, where the further IC component includes a further IC die.

Example 30 provides a computing device that includes a carrier substrate and an IC structure coupled to the carrier substrate, where the IC structure is an IC structure according to any one of examples 1-25, or the IC structure is included in the IC package according to any one of examples 26-29.

Example 31 provides a computing device according to example 30, where the computing device is a wearable or handheld computing device.

Example 32 provides a computing device according to examples 30 or 31, where the computing device further includes one or more communication chips.

Example 33 provides a computing device according to any one of examples 30-32, where the computing device further includes an antenna.

Example 34 provides a computing device according to any one of examples 30-33, where the carrier substrate is a motherboard.

Example 35 provides a method of fabricating an IC structure, the method including providing a preliminary IC structure including an interconnect layer; forming an optical interconnect including a first dielectric material over the interconnect layer; providing a semiconductor material over sidewalls of the optical interconnect; providing a second dielectric material over the semiconductor material; and providing an electrically conductive material over the second dielectric material.

Example 36 provides the method of example 35, where: forming the optical interconnect includes depositing a first layer of the first dielectric material, and patterning the first layer, and providing the semiconductor material includes depositing a second layer of the semiconductor material over sidewalls and over a top of the optical interconnect.

Example 37 provides the method of example 35, where: forming the optical interconnect includes depositing a first layer of a third dielectric material, forming a trench in the third dielectric material, and depositing the first dielectric material in the opening, and providing the semiconductor material includes prior to depositing the first dielectric material, depositing a second layer of the semiconductor material over sidewalls and over a bottom of the opening.

Example 38 provides the method of example 37, where: providing the electrically conductive material includes prior to depositing the second layer of the semiconductor material, depositing a third layer of the electrically conductive material over the sidewalls and over the bottom of the opening.

Example 39 provides the method of example 35, where: forming the optical interconnect includes depositing a first layer of a third dielectric material, forming a via opening in the third dielectric material, and depositing the first dielectric material in the via opening, and providing the semiconductor material includes prior to depositing the first dielectric material, depositing a second layer of the semiconductor material over sidewalls of the via opening.

Example 40 provides the method of any one of examples 35-39, where: providing the semiconductor material includes providing one or more of a transition metal dichalcogenide material and a thin-film semiconductor material.

Example 41 provides the method of any one of examples 35-40, further including forming a conductive interconnect over the optical interconnect, where the conductive interconnect couples with the electrically conductive material.

Example 42 provides the method of any one of examples 35-40, where: forming the optical interconnect includes forming the optical interconnect over a conductive interconnect, and providing the electrically conductive material includes depositing the electrically conductive material over and in electrical contact with the conductive interconnect.

Example 43 provides a method according to any one of examples 35-42, where the IC structure is an IC structure according to any one of the preceding examples.

Example 44 provides a process of making an IC structure, the process including providing a preliminary IC structure including an interconnect layer; forming an optical interconnect including a first dielectric material over the interconnect layer; providing a semiconductor material over sidewalls of the optical interconnect; providing a second dielectric material over the semiconductor material; and providing an electrically conductive material over the second dielectric material.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An integrated circuit (IC) structure, comprising:
a device region;
an interconnect layer over the device region;
an optical interconnect in the interconnect layer, wherein the optical interconnect comprises a dielectric material;
an electrically conductive material at least partially surrounding a portion of the optical interconnect;
a semiconductor material between the electrically conductive material and the dielectric material; and
a conductive interconnect coupled with the electrically conductive material.

2. The IC structure of claim 1, wherein:
the optical interconnect is substantially parallel to the device region, and the semiconductor material is over sidewalls of the optical interconnect.

3. The IC structure of claim 1, wherein:
the optical interconnect is substantially parallel to the device region, and the semiconductor material is over a top of the optical interconnect.

4. The IC structure of claim 1, wherein:
the optical interconnect is substantially parallel to the device region, and
in a cross-section along a plane that is orthogonal to the device region and orthogonal to the optical interconnect, the dielectric material is surrounded by the semiconductor material.

5. The IC structure of claim 1, wherein:
the optical interconnect is substantially parallel to the device region,
the optical interconnect has a first length,
the semiconductor material has a second length, the second length is a dimension of the semiconductor material that is parallel to the first length, and
the second length is smaller than the first length.

6. The IC structure of claim 5, wherein:
the dimension is a first dimension,
the electrically conductive material has a third length that is substantially the same as the second length, and
the third length is a second dimension of the electrically conductive material that is parallel to the first length.

7. The IC structure of claim 1, wherein:
a continuous portion of the semiconductor material is partially surrounding at least a majority of a length of the optical interconnect.

8. The IC structure of claim 7, wherein:
the continuous portion is a first continuous portion, and a second continuous portion of the electrically conductive material is partially surrounding at least the majority of the length of the optical interconnect.

9. The IC structure of claim 7, wherein the portion is a first portion, and wherein the IC structure further comprises:
a first conductive structure at least partially around the first portion; and
a second conductive structure at least partially around a second portion of the optical interconnect, wherein the first conductive structure and the second conductive structure comprise the electrically conductive material.

10. The IC structure of claim 1, wherein:
the portion is a first portion,
the semiconductor material comprises a first region of the semiconductor material at least partially surrounding the first portion and a second region of the semiconductor material at least partially surrounding a second portion of the optical interconnect,
the first region is coplanar with the second region, and
a further material is coplanar with and between the first region and the second region.

11. The IC structure of claim 10, further comprising:
a first conductive structure at least partially around the first region; and
a second conductive structure at least partially around the second region, wherein the first conductive structure and the second conductive structure comprise the electrically conductive material.

12. The IC structure of claim 1, wherein:
the optical interconnect is substantially orthogonal to the device region,
the semiconductor material is over sidewalls and at least partially surrounding the dielectric material, and
the electrically conductive material is over the sidewalls and at least partially surrounding the semiconductor material.

13. The IC structure of claim 1, wherein:
a thickness of the semiconductor material on a sidewall of the optical interconnect is in a range from about 0.3 to 50 nanometers, and
the thickness is a dimension of the semiconductor material on the sidewall in a plane that is substantially parallel to the device region.

14. The IC structure of claim 1, wherein:
the semiconductor material comprises a transition metal dichalcogenide.

15. The IC structure of claim 1, wherein:
the semiconductor material comprises oxygen or nitrogen.

16. The IC structure of claim 1, wherein the dielectric material is a first dielectric material, and wherein the IC structure further comprises:
a second dielectric material between the semiconductor material and the electrically conductive material.

17. An integrated circuit (IC) structure, comprising:
a backend of line (BEOL) layer;
an optical interconnect in the BEOL layer, wherein the optical interconnect comprises a first dielectric material;
a first layer comprising a semiconductor material lining sidewalls of at least a portion of the optical interconnect;
a second layer comprising an electrically conductive material over the first layer;
a third layer comprising a second dielectric material between the first layer and the second layer; and
a conductive interconnect coupled with the second layer.

18. The IC structure of claim 17, wherein:
the optical interconnect comprises an optical via, and
the conductive interconnect comprises a conductive line orthogonal to the optical via.

19. A method of fabricating an integrated circuit (IC) structure, the method comprising:
providing a preliminary IC structure comprising an interconnect layer;
forming an optical interconnect comprising a first dielectric material over the interconnect layer;
providing a semiconductor material over sidewalls of the optical interconnect;
providing a second dielectric material over the semiconductor material; and
providing an electrically conductive material over the second dielectric material.

20. The method of claim 19, wherein:
forming the optical interconnect comprises:
depositing a first layer of the first dielectric material, and patterning the first layer, and
providing the semiconductor material comprises:
depositing a second layer of the semiconductor material over sidewalls and over a top of the optical interconnect.
